(19) United States
(12) Patent Application Publication
(10) Pub. No.: US 2014/0058935 A1
(43) Pub. Date: Feb. 27, 2014

(54) MOBILE CONTACTLESS DIGITAL WATCH PAYMENT

(71) Applicant: Noel Mijares, Miami, FL (US)

(72) Inventor: Noel Mijares, Miami, FL (US)

(21) Appl. No.: 13/590,226

(22) Filed: Aug. 21, 2012

(51) Int. Cl. G06Q 20/36; H04B 5/00

(52) U.S. Cl. 705/41

(57) ABSTRACT

A mobile contact-less wrist watch payment system for making secure payments. The mobile contact-less watch payment system uses Near Field Communications and Finger Print Security Technology to create a digital watch wallet for credit card and bank card payments through a watch. The user is able to wear the watch as a digital wallet, which is unlike current applications which focus solely on having the digital wallet in a cell phone platform. The watch features security safeguards before it can be accessed to provide payments.

### CROSS-REFERENCE TO RELATED APPLICATION

### Background of the Invention

The present invention relates to payments and, more particularly, to providing payments via a watch.

Currently, credit card fraud is an ongoing problem which can occur at anytime and anywhere. Credit card fraud can occur when the card is physically stolen or when a thief is able to obtain information that compromises the integrity of an account.

Credit card fraud that occurs because the card is stolen or the CC number is compromised when the card is physically used for a transaction is a concern and can be reduced if the credit card information is properly safeguarded by a user. However, when a wallet is lost or stolen, a credit card can be used before the user has had a chance to report the card as lost or stolen. Additionally, when an unscrupulous sales person is tasked with charging a credit card, the sales person may copy the CC information before returning the card to the user.

Credit card fraud costs the credit card industry of billions of dollars and also costs users because the users have to invest money, time and energy into disputing fraudulent transactions charged to the user's account.

Therefore, there is a need to prevent the physical credit card or the compromise of data associated with the credit card account.

### SUMMARY OF THE INVENTION

In one aspect of the present invention, an embodiment of the invention includes a mobile watch for completing a purchase. The mobile watch includes a memory for storing data which comprises user preferences, user credit card information for multiple credit card accounts and security information for accessing the watch. The watch also includes an NFC transceiver configured to receive a request for payment and transmitting user payment information to a terminal; and an input system coupled with memory and a processor for receiving user security access information and payment selection information. The processor which is coupled with the memory, is configured to process inputted user security information; process the payment request; process user payment selection information; and generate an authorization message to be transmitted to the terminal.

These and other features, aspects and advantages of the present invention will become better understood with reference to the following drawings, description and claims.

### BRIEF DESCRIPTION OF THE DRAWINGS

FIG. 1 is an exemplary embodiment of the invention displaying a digital watch wallet for processing a payment.

FIG. 2 is an exemplary embodiment of the invention illustrating the features of the watch.

FIG. 3 is a flowchart for an exemplary embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a mobile contact-less watch payment system using Near Field Communications and Finger Print Security Technology to create a digital watch wallet for credit card and bank card payments through a watch. The user is able to wear the watch as a digital wallet, which is unlike current applications which focus solely on having the digital wallet in a cell phone platform. The watch features security safeguards before it can be accessed to provide payments.

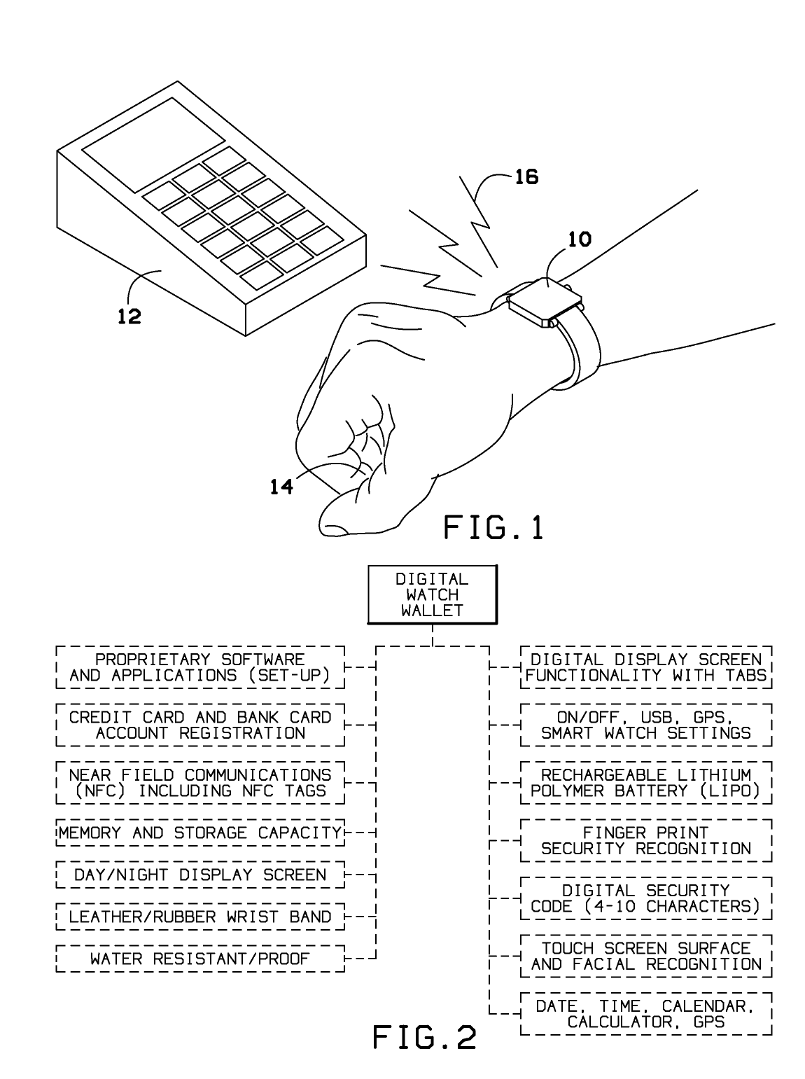

An exemplary embodiment of the invention includes a watch 10 which may be securely attached to the user's wrist as illustrated in FIG. 1. The user's fingerprint 14 may be used to access the watch 10 so that the user may make a payment via the point of sale or terminal 12.

Referring to FIG. 2, the process for using the watch is illustrated. The watch includes proprietary software and applications for setting up the user account. The user may set up the account by registering credit card and bank card information. The watch which is water resistant also includes an NFC transceiver, memory and storage capacity, a day/night display screen and a wrist band.

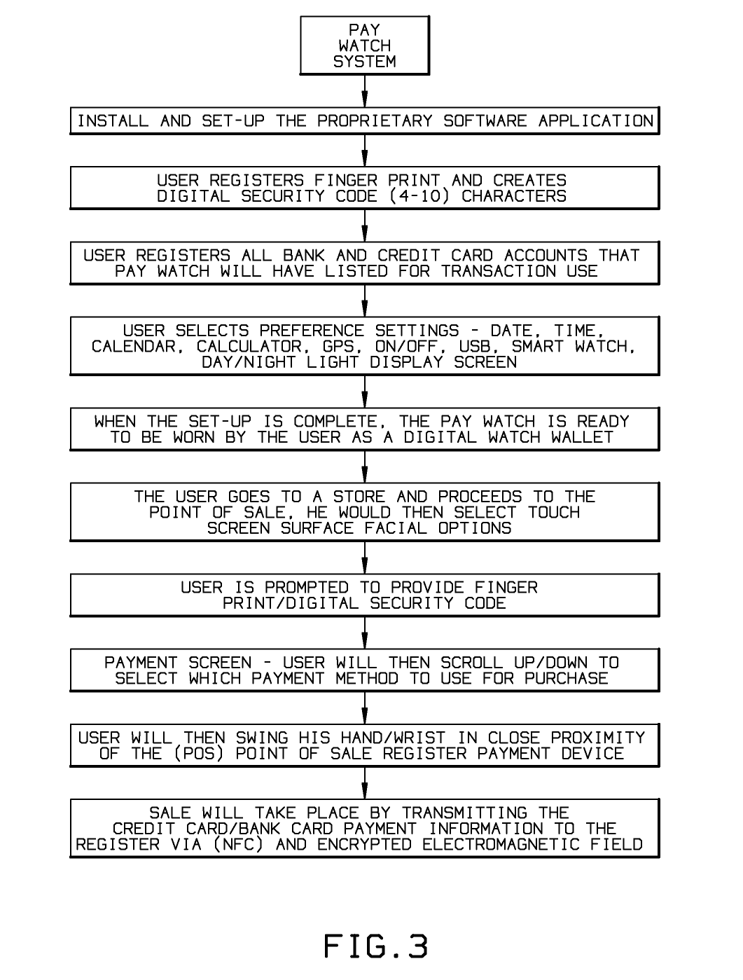

Referring to FIG. 3, the user is able to install the proprietary software application, register their fingerprint and create a digital security code. In an embodiment of the invention, the code may be 4-10 characters. The user registers their bank and credit card accounts that they intend to use with the watch for payments. Hereafter the term credit card is used to mean credit cards and bank or debit cards. The user is also able to select preference settings.

Once the registration and set up process is complete, the user may wear the watch for processing payments.

The watch of an exemplary embodiment of the current invention will allow the user to carry a digital wallet on his watch. When the user needs to pay for a service or product, he (or she) selects the pay option on the watch, which prompts a finger print reader for access to the pay option screen. Upon verification of the fingerprint of the user, the pay option screen is displayed on the face of the watch, which will permit the user to scroll and select from previously installed payment options which determine the credit or bank card to use for the transaction. The watch may also require further verification by requiring the user to enter a security code displaying the pay option screen. Once the user is verified, the price of the transaction is displayed on the screen of the watch before allowing the user to select their card. The price is also displayed on the terminal. After the card is selected, the watch loads the selected payment option and the user swings his hand next to a payment terminal where the terminal communicates with the watch via near field communication to read and accept the payment. A user may also select a default payment option so that a payment maybe processed immediately after verification of the user without requiring the user to select a particular option. The history of the transaction is saved into the watch directory and is also listed on the credit or bank card statement. An exemplary embodiment of the invention enables a user to split a payment among multiple cards and/or make a partial payment.

In an exemplary embodiment, the watch of the current invention utilizes Near Field Communications (NFC) as the source of contact-less digital mobile payment transmission under close proximity (up to 4 cm of each other) in any transaction. The (NFC) Near Field Communications establishes secured channels and only uses encryption methods when sending sensitive credit and/or bank card information. Additionally, the watch utilizes Finger Print Secured Technology to access the digital wallet. The watch works by registering credit card and bank card information into a secured web-based proprietary software application that uploads the information in an encrypted environment, so the user will have the ability to access and select a payment type to process a transaction. The watch is a digital watch wallet that requires the user to register his/her finger print and security code to access the pay portal.

Once the pay portal has been accessed, the user has the ability to select from his watch a credit card from companies such as but not limited to Visa Card, MC Card, AMEX, Discover, Bank Visa, Bank AMEX, Sears, Wal-Mart, Gas Card, etc. and use the selected card as the payment option. All transactions are carried through NFC which provides the most secured transaction type since it uses encrypted format to transmit and the proximity of the payment process is limited to centimeters.

By using a watch of the current invention, the user is no longer compromised by having to carry a wallet, or cell phone for the purpose of having a digital wallet.

It should be understood, of course, that the foregoing relates to exemplary embodiments of the invention and that modifications may be made without departing from the spirit and scope of the invention as set forth in the following claims.

What is claimed is:

1. A mobile watch for completing a purchase comprising:
a memory for storing data comprising:
user preferences;
user credit card information for multiple credit card accounts;
security information for accessing the watch;
an NFC transceiver configured to receive a request for payment and transmitting user payment information to a terminal;
an input system coupled with memory and a processor for receiving user security access information and payment selection information; and
a processor coupled with the memory and configured to:
process inputted user security information
process the payment request;
process user payment selection information; and
generate an authorization message to be transmitted to the terminal.

2. The mobile watch of claim 1, wherein the security information includes a fingerprint.

3. The mobile watch of claim 1, wherein the security information includes a digital security code.

4. The mobile watch of claim 1, wherein the payment selection information comprises a choice by a user of a particular credit card for a payment.

5. The mobile watch of claim 4, wherein the user chooses to make a payment by splitting the payment amount among multiple credit cards.

6. The mobile watch of claim 4, wherein the user chooses to make a partial payment via credit card.

7. The mobile watch of claim 1, wherein the NFC transceiver communicates with the terminal using encrypted messages.
